(19) United States
(12) Patent Application Publication
(10) Pub. No.: US 2003/0095180 A1
(43) Pub. Date: May 22, 2003

(54) Method and system for size adaptation and storage minimization source noise correction, and source watermarking of digital data frames

(76) Inventor: Dennis L. Montgomery, Reno, NV (US)

Correspondence Address: PILLSBURY WINTHROP, LLP, P.O. BOX 10500, MCLEAN, VA, 22102, US

(21) Appl. No.: 09/991,528

(22) Filed: Nov. 21, 2001

(51) Int. Cl. H04N 7/18

(52) U.S. Cl. 348/143; 348/441

(57) ABSTRACT

Methods and systems for use in, for example, video surveillance systems, are presented. The size of a digital data frame is reduced when motion across sequential frames is not observed so that data storage is minimized. The unique cyclic noise signature of a camera is observed, analyzed, and corrected for during subsequent usage of the camera. The cyclic noise signature may also be used to authenticate the source of a frame or a stream of sequential frames.

### 1. FIELD OF THE INVENTION

The present invention generally relates to data communication and transmission systems. More particularly, the present invention relates methods and systems for adapting the size of a digital data frame to minimize data storage, for correcting source noise resident in a digital data frame, and for authenticating the source of a digital data frame.

### 2. BACKGROUND

Applications such as video surveillance monitor environments and, often, the activities of individuals within these environments. In video surveillance, data are transmitted from a delivery device, such as a digital or analog camera, to a repository where the data are stored, with typically many processing steps in between. Analog systems typically store data on videocassette recorder tapes, in analog form, which tend to be bulky and cumbersome. In contrast, digital systems store the data in a digital format.

Analog systems are widely used at present. This is in large part due to lower cost of analog equipment, in terms of cameras as well as overall cost per frame of image data. Accordingly, most surveillance systems that are currently in use, even if they have digital delivery devices such as digital cameras, at some point convert the digital information into an analog form, whether that analog form is required for real-time viewing on an analog monitor, or for analog storage. Thus, in conventional systems, there typically exists an analog switch or switches that configure the data being received from many different cameras to their respective monitor for viewing and/or videocassette recorder unit.

All digital systems, while available in prototype form, have not been widely implemented due to practical cost considerations, both in terms of the digital delivery units, as well as the cost of memory necessary to store the digital data associated with digital images and sound. And those prototypes that have been proposed have significant limitations.

The activity that is captured by a video surveillance system in general will depend on the environment that is being monitored. For many environments, there are often areas that require monitoring for activity over an extended period but that do not exhibit a great deal of activity over the course of the extended period. For example, a camera might be focused on the door to a bank vault for 24 hours a day, but might only capture relatively few individuals entering the vault or merely walking by the vault door. Under conventional arrangements, the surveillance data for the monitoring are typically stored in a number of manners. In analog systems, the surveillance data is typically stored in analog form on a videocassette recorder, as noted above.

In digital systems, in order to reduce the memory requirements, proposals have been made in which the system will send to memory data that occurs upon the initiation of motion. While initiating the saving of data upon the initiation of motion has the effect of reducing memory requirements, it has the undesired effect of not providing for a continuous capture of the events that the particular digital camera recorded.

Thus, it would be desirable to have the capability to reduce the amount of storage necessary to house monitoring surveillance data without compromising the integrity of the monitoring system.

Further, data obtained from any delivery device, whether that delivery device is an analog camera or a digital camera, is affected by source noise that develops. This source noise develops as a result of a combination of an internal noise signature that corresponds to the delivery device, as well as the characteristics of the transmission line from the delivery device to the storage unit. Accordingly, this source noise will introduce a noise component into the data, thus, for example, making otherwise identical individual frames appear different from each other. It would be desirable to have the capability to eliminate or reduce such source noise present in data.

### 3. SUMMARY

The present inventions described herein provide advantageous techniques for data frame adaptation to minimize storage size, source noise cancellation, and data frame delivery device source authentication in, for example, a surveillance system.

The present invention describes methods and systems for adapting the size of a digital data frame to minimize data storage, for cancelling source noise resident in a digital data frame, and for authenticating the source of a digital data frame.

Other aspects, advantages, and objects of the present invention will become apparent as hereinafter described.

### 4. BRIEF DESCRIPTION OF THE DRAWINGS

The above and other features, and advantages of the present invention, among others, are further described in the detailed description which follows, with reference to the drawings by way of non-limiting exemplary embodiments of the present invention, wherein like reference numerals represent similar parts of the present invention throughout several views and wherein:

FIG. 1 is a block diagram illustrating a transmission system according to the present invention.

FIGS. 2A through 2D are diagrams illustrate exemplary sizes adjustments to frames based on whether motion is or is not present in an area being monitored.

FIG. 3 is a flow diagram illustrating an exemplary noise pattern discovery process according to the present invention.

FIG. 4 is a flow diagram illustrating an exemplary noise correction process according to the present invention.

### 5. DETAILED DESCRIPTION OF THE PRESENTLY PREFERRED EMBODIMENTS

The present inventions described herein provide advantageous techniques for data frame adaptation to minimize storage size, data frame noise correction to aid in pattern recognition, and data frame delivery device source authentication in, for example, a surveillance system.

The present invention describes methods and systems for adapting the size of a digital data frame to minimize data storage, for correcting source noise resident in a digital data frame, and for authenticating the source of a digital data frame.

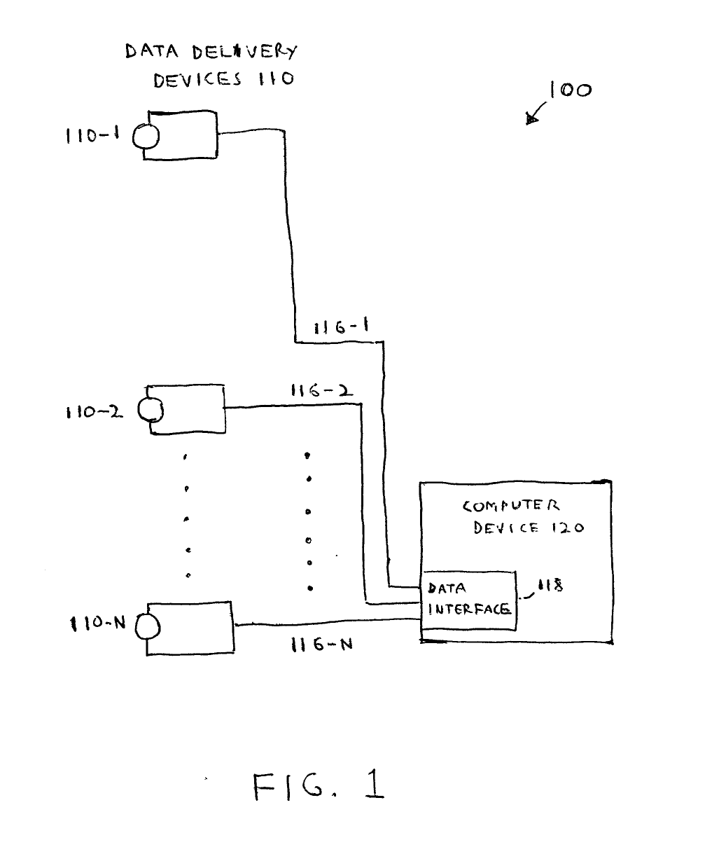

Referring first to FIG. 1, it is a block diagram illustrating an exemplary transmission system 100 according to the present invention, and various different devices that will allow for the various permutations described herein to be understood, although it is understood that this exemplary transmission system 100 should not be construed as limiting the present invention. The system 100 includes source data delivery devices 110, for example, conventional cameras 110-1 to 110-N, each of which is connected to a computer device 120 at a data interface 118 via respective transmission equipment 116-1 to 116-N.

The source data delivery devices 110-1 to 10-N preferably contain systems for detecting both images and sound, although devices that can reproduce images or sound but not both are also within the scope of the present invention. The source data delivery devices 110 can be analog or digital.

Further, source delivery devices 110 generate noise that becomes overlaid onto the recorded signal. And delivery devices that are most susceptible to producing large amounts of noise are those devices 110 that record images, in other words a camera. And while there exists high quality cameras that produce only slight amounts of such noise, cameras used in many surveillance environments are often of a low grade quality. As such, the cameras often generate a substantial amount of noise that is overlaid onto the actual image that is being recorded.

For devices 110 that record images, this noise results from a combination of the internal elements that are used to record the image, including the optical systems, transducers, digital circuits, the power source and AC/DC converters, and the like. It has been found, however, that once a camera has been turned on for a period of time, it reaches a steady state operation, such that the noise will repeat in a cyclic noise pattern. The present invention, as described hereinafter, exploits this property to eliminate cyclic noise from the recorded image. Thus, certain aspects of the present invention correct for the noise signature of devices 110 such as cameras.

The environment in which a device 110 is placed has also been found to be significant. If a device 110 is analog, the respective transmission equipment 116 is typically analog, and if device 110 is digital, the respective transmission equipment is typically digital. A conventional arrangement for an analog camera device 110 includes analog transmission equipment 116A that includes analog transmission lines and amplifiers placed at lengths along the analog transmission lines to refresh the analog signals as suitable. A typical arrangement for a digital camera device 110 includes digital transmission equipment 116D that typically includes only an optical transmission line, as digital signals can travel along an optical transmission line distances that are much greater than analog signals can travel, as is known.

In most systems, however, within the data interface 118 is located an analog switch that allows for switching streams of data from various cameras to various monitors and/or recording equipment. As such, at this point, conversion of digital data, if it has previously been obtained, to analog form, is still required in many instances. Thus, irrespective of the type of camera used, analog or digital, the data interface 118 in many cases will include an analog to digital (A/D) converter after the analog switch so that analog signals output from the switch can be converted to digital form for input into the computer 120. And for such systems which contain digital recording devices 110, before the analog switch there exists a digital to analog (D/A) converter that converts the digital signals to analog form, so that they can be operated upon by the analog switch. It is apparent, therefore, that in addition to the source noise that is generated from the recording device 110, that the transmission medium 116 will also contribute noise as well, particularly from signal degradation and amplifier distortion in the analog context, and from digital to analog conversion and analog to digital conversion in the digital context.

And while the system as above-described will be used for the remainder of the discussion herein, it should be understood that these are illustrative examples and many other arrangements are possible.

As mentioned previously, devices 110, and particularly low quality cameras, generated a cyclic noise pattern, which pattern is further altered as a result of the transmission medium 116. One obvious component of this noise tends to be from power used to drive the electrical components. While a DC voltage is typically used to drive circuit components, this DC voltage is typically obtained as a result of a conversion from an AC source, which in the United States oscillates at 60 Hz/sec. Thus, this AC noise becomes one component of the source noise, and can have a particularly severe effect since most image devices 110 record images at 30 frames/sec, a frequency that is relatively close to the oscillating frequency of the AC power signal.

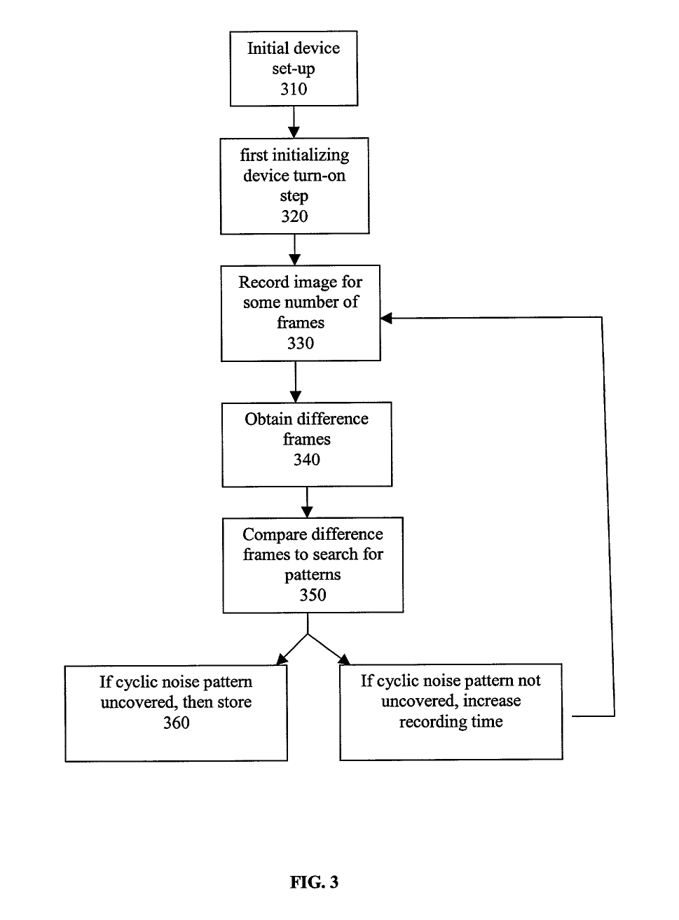

As mentioned above, the present invention exploits the existence of this cyclic noise property to eliminate cyclic noise from the recorded image, and how it does that will now be described with respect to the flowchart of FIG. 3. As indicated by step 310, an initial set-up is first preferably done, so that the recording device 110 and the transmission medium 116 associated with that device are in place. This ensures stability of the initializing routine. Once step 310 is complete, the initializing steps are begun, with the first initializing step 320 being to turn on the device 110 after the computer 120 is configured to record the output of the device 110. It is noted that in this initial configuration, the amount of time that the device 110 will require to heat up before it exhibits a cyclic noise pattern is unknown.

When initially turned on, the camera records the image taken from a known color pattern, such as a known white blotter. Initially, as shown by step 330, the image is recorded for some number of frames, typically in the range of 200-300 frames. Each of these frames is then compared against a stored “white” image that contains pixel representations corresponding to the actual known color pattern to obtain a difference frame, as shown by step 340. In the following step 350, these difference frames are compared against one another to determine if there is any repetition of patterns between them. While conventional pattern recognition algorithms can be used, preferably the pattern recognition algorithm described in U.S. Application No. bearing attorney reference number 042503/0259665 entitled “Method And Apparatus For Determining Patterns Within Adjacent Blocks Of Data,” filed on Oct. 31, 2001, which is assigned to the same assignee as the present invention, is used. For purposes of using the pattern recognition described in this U.S. application No. bearing attorney reference number 042503/0259665 and the nomenclature therein, each frame can be a reference frame, and be compared to each of the other frames, with each of the other frames being a target frame for purposes of that comparison. In order to maximize the comparisons, each frame can be designated a reference frame with the other frames being target frames, although it will be appreciated that such a number of comparisons leads to redundant comparisons, and thus a lesser number of comparisons is needed.

If, following step 350, a cyclic noise pattern is uncovered therein, that cyclic noise pattern can be stored in step 360.

If, however, a cyclic noise pattern was not uncovered, then the recording device 110 is operated in step 370 for a period of time longer than it was previously, and the recording stored. Thereafter, step 350 is repeated, using the larger number of recorded frames to uncover the cyclic noise pattern. Steps 360, 370, and 350 then repeat until a cyclic noise pattern is found.

In terms of the typical length of time that it takes to uncover the cyclic noise pattern, it has been determined that in more recent digital cameras, such as Fujitsu Series XV, that the cyclic noise pattern will appear after a heat-up time of approximately two minutes, and that the cyclic noise pattern repeats in a range of typically every 250-350 frames. For older analog models, however, the heat up time required can be on the order of days, although the cyclic noise pattern once established will still be on the order of 2,000-4,000 frames.

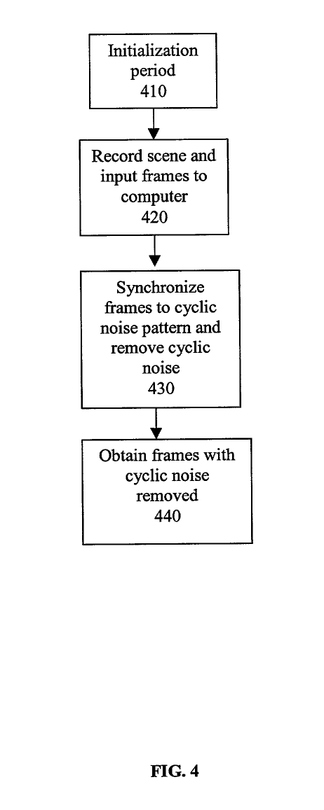

Once the cyclic noise pattern is obtained, then, as shown in FIG. 4, it can be used to remove the noise from the recorded data, and thus obtain a better representation of that which is being detected, such as the image if the device 110 is a camera. As shown in step 410, once the recording device 110 is turned on, an initialization period corresponding to the previously determined heat-up period is preferably allowed to occur, so that the device 110 enters a steady state operation. Once this period of time passes, recording of the desired scene can begin, as shown by step 420. And once recording begins, each recorded frame is input into computer 120, and, as shown by step 430, is synchronized with a corresponding frame from the cyclic noise pattern to remove the cyclic noise therefrom. Accordingly, as shown by step 440, each frame with the cyclic noise removed therefrom is obtained. The frames can then be used as desired in subsequent surveillance operations.

It should be also be noted that it has been determined that this cyclic noise pattern is substantially frequency independent. Thus, while a known white blotter was indicated as being used above, any suitable solid material of known color may be used, as long as the known color is identical to the color of mathematically represented benchmark frames of data used for comparison.

In another aspect of the present invention, the present invention exploits the obtained cyclic noise pattern. As described above, the cyclic noise pattern is preferably detected within each frame and eliminated or minimized. According to another aspect of the present invention, watermarking of particular frames generated by a source recording device 110 is performed using the noise signature. In a presently preferred embodiment, the camera noise is not removed for every nth frame to obtain a detectable watermark indicative that the frame actually comes from that particular source recording device 110. If a different source recording device 110′ were instead used, a different noise pattern would exist, and the expected noise pattern would not be found. Thus, this noise creates a digital signature that will identify the frame as having come from the particular recording device 110 rather than from a different recording device 110′, thus foiling any attempts to introduce a substitute stream of data. In this regard, in order to be able to later in time verify the specific camera that recorded a specific sequence, when storing the specific sequence, it is preferable that the cyclic noise pattern also be stored with the sequence, to ensure that such verification can be made later in time.

It should also be noted that although the cyclic noise removal of the present invention is described in terms of real-time elimination of the cyclic noise pattern, that the cyclic noise removal can operate upon data that has been previously stored. And while having the actual recording device used to record the data is desirable, noise patterns can be detected in stored data even without having the actual camera.

As described above, if a surveillance system attempts to store recorded data digitally, the memory requirements can be quite large and expensive. Minimizing the storage space required for storing data, for example, frames of digital data, is a common objective of data delivery systems. As noted previously, while systems exist which will not store data during periods when motion is not detected, that fact that a continuous record is unavailable is undesirable.

And while compression routines exist which can operate to minimize the amount of recorded data that needs to be stored, that amount of data can still be quite large. In general, the amount of data that is recorded by the video surveillance system 100 depends on the environment that is being monitored. For many environments, there are often areas that require monitoring for activity over an extended period but that do not exhibit a great deal of activity over the course of the extended period. For example, the camera 110 might be focused on the door to a bank vault for 24 hours a day, but might only capture relatively few individuals entering the vault or merely walking by the vault door. This can easily be contrasted with the case of frames from a motion picture or from a video camera that is trained on a busy area with much traffic.

Exemplary aspects of the present invention exploit monitoring of environments that do not exhibit a great deal of activity over the course of an extended period of monitoring. Rather than storing all of the surveillance data recorded, another aspect of the present invention reduces the amount of storage by reducing the stored image resolution for frames of data corresponding to no motion being detected.

Frames of digital image data are typically made up of pixels, with each pixel having, for example, a 16, 24, or 32 bit RGB representation. Since the resolution of a particular frame in increases as the number of pixels used to represent the frame increases, to conserve data storage space that would otherwise be taken up by filming of these environments exhibiting no activity for extended periods, after a predetermined period of time of storing a full-sized frame during which no motion is observed, the resolution of the stored frame is reduced to some fraction, for example, one-quarter, of the size of the full-sized frame. The smaller frame size is used until a frame with motion appears. Then, the stored frame size is increased to a larger frame size. It should be understood that the lower the fraction, the greater the reduction in storage space typically needed to store the data. While lesser or greater than 25% resolution can be stored, this amount has been found to be a good compromise between maintaining clarity of the image and reducing data stored, which, as will be appreciated, are competing requirements.

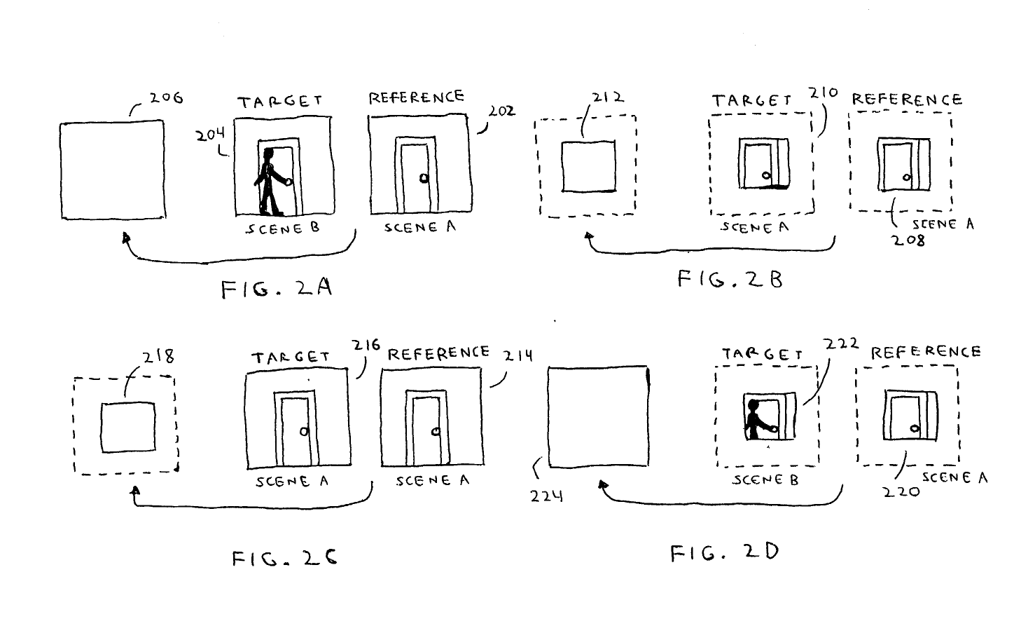

FIGS. 2A through 2D illustrate the various operations necessary to implement the reduced resolution frame storage. In FIGS. 2A through 2D, an exemplary frame storage size of 640×480 pixels (prior to any compression taking place) is used, with a reduced resolution frame storage size of 320×240 pixels (prior to any compression taking place) if no differences indicative of motion or activity occurring in the environment or area are monitored. Preferably, the computer device 120 performs a frame by frame comparison for a particular camera of the cameras 110. It is understood that even with cyclic noise patterns removed, differences between images will still result, even if the actual scene recorded was the same. Accordingly, differences between frames that exceed a certain predetermined threshold, such as 3-5% of tolerated loss, are used to indicate the introduction of motion to a scene. It is noted that the predetermined threshold between adjacent frames containing motion will be exceeded because the new object contained in the frame will significantly alter certain bits within the frame. Further, it is preferable that the comparison operations operate upon the full resolution frame size, and that the reduced frame size be stored once it is determined that motion between adjacent frames does not exist.

Whether adjacent frames are within the threshold can be determined using pattern recognition techniques, and preferably the pattern recognition technique described in the U.S. application bearing attorney reference number 042503/0259665 mentioned above. Generally, and particularly for FIGS. 2A through 2D, the reference frame is initially set to an initial frame of a sequence of frames, while the target frame is initially set to a subsequent frame of the sequence of frames. Once the reference and the target frames are compared with one another, the subsequent frame that was the target frame is redesignated as a new reference frame, and another subsequent frame that follows the subsequent frame is redesignated as a new target frame. The process is preferably repeated for each successive frame in the sequence.

It should be noted that according to the preferred embodiment, the recording device 110 is fixed in position, does not zoom, and always records the same background scene. Thus, processing can be simplified from the situation where the recording device 110 is not fixed. If not fixed, then a no-motion reference frame 214 cannot be obtained, and a sequential comparison of frames is required. It is noted, however, that since a sequential comparison of frames may already be obtained if compression in addition to the frame size reduction described herein is being used, that comparison can be used rather than using a no-motion reference frame that is always the same.

In FIG. 2A, a 640×480 reference frame 202 of digital data that has been previously recorded as a 640×480 size frame that captured a scene A is compared with a subsequent 640×480 target frame 204 of digital data. As shown, this subsequent frame contains a scene B that that is different from scene A, thus indicating that there is activity or motion that occurs that engenders differences between the frames 202, 204 and causes the predetermined threshold to be exceeded. Since the predetermined threshold is exceeded, the scene B is recorded at the larger 640×480 frame size. Subsequent frames 206 continue to be sized at the larger 640×480 frame size until the predetermined threshold is not exceeded for some window of time, typically 200-300 frames of no activity.

In FIG. 2B, a 640×480 reference frame 208 of digital data representing scene A that has previously been recorded as a 320×480 reduced frame is compared with a 640×480 target frame 210 of digital data, which captures a subsequent scene A that falls within the predetermined threshold. Since subsequent scene A falls within the predetermined threshold, it is also recorded as a reduced 320×480 frame size, indicative of there being no discernible activity or motion that occurs. Preferably, subsequent frames 212 continue to be sized at the smaller 320×240 frame size until differences between frames are recognized that cause the predetermined threshold to be exceeded.

In FIG. 2C, a 640×480 reference frame 214 of digital data that was recorded at 640×480 of scene A is compared with a subsequent 640×480 target frame 216 of digital data, which captures a subsequent scene A that differs by less than the predetermined threshold. Since initial scene A and subsequent scene A are within the threshold, it is concluded that there is no discernible activity or motion that occurs. Thus, the recorded frame size is thus adjusted to the smaller 320×240 frame size if the window of time as referred to above has elapsed. If the window of time has not elapsed the subsequent scene A is stored as a 640×480 frame, but a counter corresponding to the window of time is incremented. Subsequent frames 218 that also are within the predetermined threshold after the window of time has been exceeded are thus sized at the smaller 320×240 frame size until differences that cause the predetermined threshold to be exceeded are recognized.

In FIG. 2D, a 640×480 reference frame 220 of digital data that captured scene A had been recorded at 320×240. This reference frame is compared with a 640×480 target frame 222 of digital data, which captures a subsequent frame of scene B that differs from scene A by more than the predetermined threshold, indicating that there is activity or motion that occurs that engenders differences between the frames 220, 222. Since the predetermined threshold is exceeded, the subsequent frame size is adjusted to the larger 640×480 frame size. Preferably, subsequent frames 206 are sized at the larger 640×480 frame size until the predetermined threshold is no longer exceeded, and the window of time has elapsed.

In a modification of the embodiment described above, if the last recorded frame was recorded at a small size 320×240 frame size, than the comparison operations, instead of comparing two different 640×480 frames will compare two 320×240 frames, which reduces the number of comparison operations needed, and if the predetermined threshold is exceeded, then the entire 640×480 size frame that was obtained but not used for the comparison operations is stored.

Other modifications are also within the scope of the present invention. For example, the order that the steps are implemented can vary.

Further, the cyclic noise that is detected can be used for other purposes. For example, in a typical installation the cameras, amplifiers, and the like will all be turned on and being used continuously, 24 hours a day. As a result, they tend to operate in a stable manner, and thus the cyclic noise pattern can be eliminated. If, however, the camera, amplifier or another component begins to drift from its stable operating characteristics, a new cyclic noise pattern will develop that is different from the originally obtained cyclic noise pattern. As a result, the watermark that is occasionally passed will differ, as described above. When this occurs, the difference will cause an alert, as noted above. While this alert may indicate suspicious circumstances, it could also indicate that one of the components, such as the camera or amplifier, may fail in the near future, since an early indicator that a device will fail is unstable operation, which can thus cause the drift. Accordingly, the present invention can be used as an early warning system that can indicate that a particular device may soon completely fail. If a particular device is found to be unstable and needs to be replaced, it is noted that the initial set-up as previously described will need to be performed again, since the new device will cause a different cyclic noise pattern to result.

Further, an even further reductions in the size of the stored frame can be made. One example of that is if some predetermined percentage of continuous frames are entirely black, such as 98%, indicating lights are out and no image is detectable. In such circumstances a further reduction in stored frame size to ⅛th of the original frame size may be warranted.

Although various preferred embodiments have been described in detail above, those skilled in the art will readily appreciate that many modifications of the exemplary embodiment are possible without materially departing from the novel teachings and advantages of this invention. Variations on the present invention will become readily apparent to those skilled in the art after reading this description, and the present invention and appended claims are intended to encompass such variations as well.

I claim:

1. In a video surveillance system used to monitor an area, a method of conserving data storage by storing data for each of a plurality of sequential frames at different resolutions depending upon an indication of motion being received, each frame comprised of a plurality of bits, the method comprising:
comparing a reference frame to a frame to obtain a difference;
determining if the difference exceeds a predetermined threshold;
operating on the frame at a regular resolution if the predetermined threshold is exceeded and at a reduced resolution that is less than the regular resolution if the predetermined threshold is not exceeded for the frame and a predetermined number of previous frames; and
repeating the steps of comparing, determining and operating for a plurality of subsequent frames that follow the frame.

2. The method according to claim 1, wherein the predetermined number of previous frames comprises a window of time.

3. The method according to claim 1, wherein the predetermined number of previous frames is zero.

4. The method according to claim 1, wherein the reduced resolution is less than one half of the regular resolution.

5. The method according to claim 1, further comprising,
prior to the step of comparing, setting the reference frame to an initial frame of the plurality of sequential frames.

6. The method according to claim 5, further comprising,
prior to the step of comparing, setting the target to a subsequent frame of the plurality of sequential frames.

7. The method according to claim 6, further comprising,
prior to the repeating step, redesignating as the reference frame the subsequent frame that was the target frame and redesignating as the target frame another subsequent frame that follows the subsequent frame.

8. The method according to claim 1 wherein the step of operating compresses the frame using one of the regular resolution and the reduced resolution.

9. The method according to claim 1 wherein the step of operating stores the frame using one of the regular resolution and the reduced resolution.

10. In a video surveillance system using a data delivery device to monitor an area, a method of correcting for cyclic noise resident in a plurality of sequential frames, each frame comprised of a plurality of bits, the method comprising:
installing the data delivery device in a position to monitor the area;
obtaining a cyclic noise pattern corresponding to the data delivery device; and
monitoring the area using data delivery device, thereby obtaining the plurality of sequential frames; and
removing the cyclic noise resident in at least certain ones of the plurality of sequential frames to obtain a corrected plurality of sequential frames.

11. The method according to claim 10, further comprising:
authenticating at least one frame in the plurality of sequential frames by one of not removing the cyclic noise from the one frame and reintroducing the cyclic noise removed from the one frame, thereby using the cyclic noise as a watermark.

12. The method according to claim 10, further comprising:
comparing one frame of the plurality of sequential frames with another frame of the plurality of sequential frames to obtain a difference;
determining if the difference exceeds a predetermined threshold; and
operating upon the another frame at a regular resolution if the predetermined threshold is exceeded and at a reduced resolution that is less than the regular resolution if the predetermined threshold is not exceeded for the frame and a predetermined number of previous frames.

13. The method according to claim 12, wherein the predetermined number of previous frames comprises a window of time.

14. The method according to claim 12, wherein the predetermined number of previous frames is zero.

15. The method according to claim 12, wherein the reduced resolution is less than one half of the regular resolution.

16. The method according to claim 12 wherein the step of operating stores the frame using one of the regular resolution and the reduced resolution.

17. The method according to claim 16 further including the step of storing the cyclic noise with the plurality of sequential frames.

18. The method according to claim 10 wherein the step of installing further includes the step of installing at least one component, and further including the steps of
determining that the cyclic noise has changed;
replacing one of the data delivery device and the one component; and
repeating the step of obtaining the cyclic noise pattern to obtain a new cyclic noise pattern.

19. The method according to claim 10 further including a initialization warm up period before the step of monitoring during which period the data delivery device is turned on.

20. The method according to claim 10 wherein the step of obtaining a cyclic noise pattern includes the steps of:
recording for a period a predetermined test pattern of frames;
obtaining a difference from a reference pattern for each of the predetermined test pattern of frames obtained during the period;
using the difference to search for the cyclic noise;
storing the cyclic noise if the cyclic noise is detected;
setting the period to a longer period if the cyclic noise is not detected; and
repeating the steps of recording, obtaining, using and setting until the cyclic noise is detected.

21. In a video surveillance system having a fixed position camera, a method of conserving data storage by adjusting a frame storage size at which individual frames of a plurality of sequential frames are stored depending upon an indication of motion being received, each frame comprised of a plurality of bits, the method comprising:
monitoring the frames of the plurality of sequential frames for differences above a predetermined threshold;
reducing the frame storage size for a first group of subsequent frames from a larger frame storage size to a smaller frame storage size when the predetermined threshold is not exceeded; and
increasing the frame storage size for a second group of the subsequent frames from the smaller frame storage size to the larger frame storage size when the predetermined threshold is exceeded.
